(19) United States
(12) Patent Application Publication
(10) Pub. No.: US 2005/0011868 A1
(43) Pub. Date: Jan. 20, 2005

(54) Hybrid laser-arc welding method with gas flow rate adjustment

(76) Inventors: Olivier Matile, Paris (FR); Karim Chouf, Epinay S/Seine (FR); Philippe Leferbve, Melilan (FR)

Correspondence Address: Air Liquide;Intellectual Property, 2700 Post oak Blvd., Suite 1800, Houston, TX, 77056, US

(21) Appl. No.: 10/489,444

(22) PCT Filed: Jul. 29, 2002
(86) PCT No.: PCT/FR02/02719

(30) Foreign Application Priority Data
Sep. 13, 2001 (FR) 0111854

(51) Int. Cl. B23K 26/20; B23K 9/16

(52) U.S. Cl. 219/121.64; 219/74

(57) ABSTRACT

The invention concerns a hybrid arc-laser method for welding metal parts, such as a tube or tailored blanks by producing at least a weld joint between edges to be welded and by using a laser beam and an electric arc combined with each other so as to melt and subsequently solidify the metal along said edges to be welded. Said method consists in: (a) striking at least a pilot arc between an electrode and a hybrid welding head nozzle, said electrode being powered with electric current and being contacted with a first gas input in said hybrid welding head, said first gas having a gas composition capable of promoting sparking of the pilot arc; (b) transferring the thus sparked pilot arc to the edges of the part(s) to be welded; and (c) feeding said hybrid welding head with a second gas so as to obtain a protective gaseous atmosphere consisting of a mixture of the first gas and the second gas, said protective gaseous atmosphere being evacuated towards the welding zone by said hybrid welding head and protecting at least part of the welding zone during welding of the weld joint by combining the laser beam and the electric arc, the volume flow rate of the first gas (Q1) and the volume flow rate of the second gas (Q2) being adjusted such that: 0<Q1<Q2, preferably, 2<Q2/Q1<55.

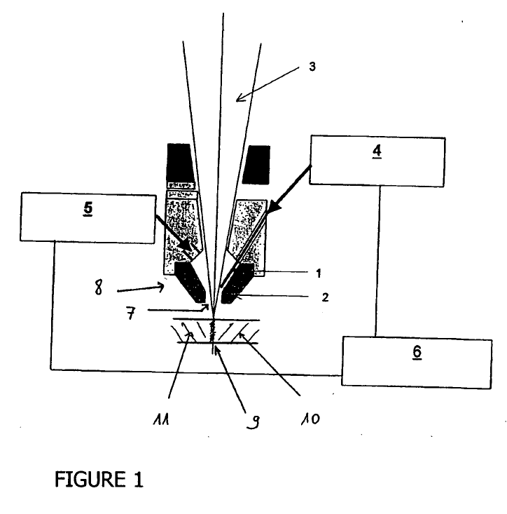

The present invention relates to a hybrid welding process and to a hybrid welding set combining a laser beam and an electric arc, in particular a plasma arc, using special gases or gas mixtures as electric arc striking gases and laser beam assistance gases, and to its application to the welding of pipes or tubes or to the welding of tailored blanks, especially those that can be used in the automobile industry.

In plasma arc welding, correct and effective striking of the arc, at the start of a welding operation, is of paramount importance and is indispensable since, if there is no striking at all, the welding cannot take place for lack of an electric arc, while if the arc is struck incorrectly this may result in damage to certain components of the welding head, for example the nozzle.

At the present time, there are various ways in which to strike an arc in an electric arc torch, namely:
striking by a pilot spark resulting from the use either of a high voltage, typically from 2 000 to 5 000 volts, or a high frequency, for example 10 to 50 kHz. However, this method has the drawback of causing electromagnetic interference—by radiative or conductive means—with a risk of damaging the electrical or electronic equipment;
striking by a pilot arc with a low-power electric arc created between the electrode and the nozzle of the torch. This technique has the advantage of causing no electromagnetic interference.

In both cases, when the arc is struck, it is then transferred onto the workpiece(s) to be welded.

However, whatever the technology employed, arc striking preferably takes place in a gas having a low ionization potential, which gas must also be inert so as not to cause any contamination or deterioration of the electrode and also not to react negatively with the molten metal.

As may be seen in the following table, argon meets these conditions as it is inert and has a relatively low ionization potential, unlike nitrogen or CO₂, which, although having even lower ionization potentials, may react with the molten metal, for example, forming, nitrides in the case of nitrogen and damaging the tungsten electrode in the case of CO₂.

| | Ionization potential |
|---|---|
| Gas | (eV) |
| He | 24.46 |
| Ar | 15.68 |
| N₂ | 15.51 |
| CO₂ | 14.4 |

Furthermore, in plasma arc welding, it is customary to use plasma gases containing mainly argon.

In other words, in plasma arc welding, argon or an argon-based gas is used only to strike the arc, after which the actual welding operation is carried out.

Moreover, in laser beam welding, in particular with laser sources of the CO₂ gas type, owing to the high specific power levels involved, generally a few kilowatts, production of the weld relies on the phenomenon of localized melting of the material at the point of impact of the laser beam where a capillary, filled with metal vapors ionized at high temperature, forms, said vapor capillary being called a keyhole. The walls of this keyhole are formed from molten metal.

This keyhole plays an important role as it allows energy to be transferred directly to the core of the material.

The weld pool thus formed and maintained is progressively displaced between the workpieces to be joined together, depending on the relative displacement of the laser beam over the workpieces to be welded, and the metal of the welded joint solidifies after the laser beam has passed, ensuring contiguous joining of the workpieces.

The appearance of the keyhole is accompanied by the formation of a metal vapor plasma, that is to say an electrically neutral ionized gas mixture at a temperature of several thousands of degrees.

The metal vapor plasma results from good coupling between the laser beam and the workpiece, and is therefore inevitable. This type of plasma absorbs a small amount of the incident energy and does not appreciably modify the width and the depth of the weld bead.

Under certain conditions, relating to speed, power, nature and composition of the gas, configuration, etc., the metal vapor plasma transfers some of its energy to the shielding gas used to shield the welding zone from any contamination by atmospheric impurities, and there is then a risk of creating another plasma arising from the shielding gas.

In actual fact, the creation of such a plasma from the shielding gas may absorb energy from the incident laser beam and, in this case, the weld bead becomes broader at the surface and penetrates much less into the thickness of the workpieces to be welded.

To counteract the creation of the shielding gas plasma, it is necessary to use a gas having a high ionization potential and it turns out that helium is the most appropriate gas for limiting the occurrence of this type of plasma.

In recent years there has been developed, in parallel with the abovementioned welding processes, a welding process called laser/arc hybrid welding, based on the combination of a laser beam and an electric arc.

Laser/arc hybrid welding processes have been described, in particular in documents EP-A-793558; EP-A-782489; EP-A-800434; U.S. Pat. No. 5,006,688; U.S. Pat. No.5,700,989; EP-A-844042; “Laser GTA Welding of aluminum alloy 5052” by T. P. Diebold and C. E. Albright, 1984, pages 18-24; SU-A-1815085 and U.S. Pat. No. 4,689,466; “Plasma arc augmented laser welding” by R. P. Walduck and J. Biffin, pages 172-176, 1994; and “TIG or MIG arc augmented laser welding of thick mild steel plate”, Joining and Materials, by J. Matsuda et al., pages 31-34, 1988.

In general a plasma/laser, or, more generally, laser/arc hybrid welding process is a combined or mixed welding process that combines electric arc welding with a laser beam. The laser/arc process consists in generating an electric arc between an electrode, which may or may not be consumable, and the workpiece to be welded, and in focusing a powerful laser beam, especially a YAG-type or CO₂-type laser, in the arc zone, that is to say near or in the joint plane obtained by joining together, edge to edge, the parts that are to be welded together.

Such a hybrid process makes it possible to considerably improve welding speeds compared to laser welding alone or to arc welding alone and, in addition, it makes it possible to appreciably increase the tolerances on positioning the edges before welding and also the tolerated gap between the edges to be welded, in particular compared to laser welding alone, which requires high precision in positioning the parts to be welded because of the small size of the focal spot of the laser beam.

The use of a laser/arc hybrid welding process requires the use of a welding head that makes it possible to combine the laser beam, its focusing device and a suitable welding electrode.

Several head configurations are described in the abovementioned documents and it may be stated, in summary, that the laser beam and the electric arc or plasma jet may be delivered by one and the same welding head, that is to say they leave via the same orifice, or else via two separate welding heads, one delivering the laser beam and the other the electric arc or plasma jet, the beam and the arc/plasma being combined in the welding zone, as taught for example by documents WO-A-01/05550 and EP-A-1 084 789.

Hybrid laser/arc processes are reputed to be perfectly suitable for welding tailored blanks for the automobile industry, since they make it possible to obtain a weld bead that is well wetted and free of undercuts, as mentioned in documents EP-A-782 489 and “Laser plus arc equals power”, Industrial Laser Solutions, February 1999, pages 28-30.

During production of the welded joint, it is essential to use an assistance gas, in order to assist the laser beam and to shield the welding zone from external attack, and a gas for the electric arc, in particular a plasma gas serving to create the arc plasma jet in the case of a plasma arc process.

Thus, it will be readily understood that, when a laser source is coupled with a plasma arc welding device in order to implement a laser/plasma arc hybrid welding process, the above problem then becomes very complex as it is then necessary not only to avoid the formation of the shielding gas plasma near the weld pool, but also to be able to obtain correct striking of the arc generated by the electrode.

As explained above, the plasma gas must essentially contain argon in order to allow effective striking of the arc.

However, upon contact with the metal vapor plasma generated by impact of the laser beam on the material to be welded, an argon-rich plasma gas may easily ionize and create a plasma that absorbs the laser beam and is therefore deleterious to the quality of the weld, as it reduces the depth of penetration of the beam.

Conversely, the gas for shielding the weld pool must contain predominantly helium in order to prevent the formation of an absorbent plasma.

However, if the end of the electrode is surrounded by and in contact with helium in a high proportion, it will not be possible to correctly strike the plasma arc.

It is an object of the present invention therefore to propose a laser/arc hybrid welding process that does not pose these problems, that is to say a laser/arc, particularly laser/plasma arc, hybrid welding process with effective striking and no or almost no absorbent plasma being formed.

The solution of the invention is therefore a laser/arc hybrid welding process for welding one or more metal workpieces to be welded by producing at least one welded joint between the edges to be welded, carried by said metal workpiece or workpieces, said welded joint being obtained by using at least one laser beam and at least one electric arc, which combine with one another so as to cause melting followed by subsequent solidification of the metal along said edges to be welded, which process is carried out as follows:
(a) striking of at least one pilot arc between an electrode and a nozzle of a hybrid welding head, said electrode supplied with electrical current and being brought into contact with a first gas introduced into said hybrid welding head, said first gas having a gas composition conductive to striking of the pilot arc;
(b) transfer, after step (a), of the pilot arc thus struck to the edges of said workpiece or workpieces to be welded; and
(c) supply of said hybrid welding head with a second gas so as to obtain a gaseous shielding atmosphere formed from a mixture of the first gas and the second gas, said gaseous shielding atmosphere being expelled toward the welding zone by said hybrid welding head and shielding at least part of the welding zone during welding of the welded joint by the combination of the laser beam and the electric arc, the volume flow rate of the first gas (Q1) and the volume flow rate of the second gas (Q2) being adjusted in such a way that: 0<Q1<Q2.

Depending on the case, the process of the invention may include one or more of the following technical features:
at step (a), the first gas forming the gaseous striking composition contains more than 50% argon by volume, preferably 70 to 100% argon by volume;
at step (a), the first gas forming the gaseous striking composition also contains at least one additional, non-oxidizing, compound chosen from helium, H₂ and N₂ in a concentration of 0.05 to 30% by volume;
at step (c), the second gas contains at least 40% helium by volume, preferably 50 to 100% helium by volume;
at step (c), the second gas contains, in addition, at least one additive compound chosen from argon, H₂, O₂, CO₂ and N₂ in a concentration of 0.05 to 30% by volume;
the volume flow rate of the first gas (Q1) and the volume flow rate of the second gas (Q2) are adjusted in such a way that: 2<Q2/Q1<55;
the volume flow rate of the first gas (Q1) and the volume flow rate of the second gas (Q2) are adjusted in such a way that: 3<Q2/Q1<50, preferably 10<Q2/Q1<40;
at step (c), the laser beam and the plasma arc are delivered, being combined together, via the same orifice of a welding nozzle;
the gaseous shielding atmosphere formed from a mixture of the first gas and the second gas obtained at step (c) contains helium and argon, the proportion of helium by volume being greater than the proportion of argon by volume;
the workpiece or workpieces to be welded have a thickness between 0.1 and 70 mm, preferably between 0.3 and 50 mm;
the workpiece or workpieces to be welded are tailored blanks forming components of an automobile body;
the workpiece or workpieces to be welded are made of a metal or a metal alloy chosen from clad or unclad steels, particularly joining steels, high-yield-strength steels, carbon steels, steels having on the surface a zinc alloy coating, stainless steels, aluminum or aluminum alloys;
at step (c), the gaseous shielding atmosphere contains argon and more than 60% helium, and optionally one or more compounds chosen from H₂, O₂, CO₂ and N₂;
the respective volume flow rates of said first and second gases are adjusted during the transfer in step (b) of the pilot arc or immediately after transfer of the pilot arc, preferably after the transfer of the pilot arc;
the workpiece to be welded is welded so as to obtain a tube;
the action of bringing the welding head up to the workpiece or workpieces to be welded in order to create a plasma arc is carried out after a pilot arc has been detected, preferably said action is carried out almost simultaneously with the delivery at step (c) of the gaseous shielding gas containing at least 50% helium by volume; and
the laser beam is emitted simultaneously with or subsequently to the formation of the plasma arc so that said beam is combined with the arc plasma.

The invention also relates to a process for manufacturing automobile body components, in which workpieces forming automobile body components are welded together by implementing a hybrid welding process according to the invention, and to a process for manufacturing a longitudinally or spirally welded tube or pipe, in which the edges of the tube or pipe are welded together by implementing a hybrid welding process according to the invention.

The gas mixture containing said first and second gases contains a proportion of the first gas such that it does not form a gas plasma coming from this gas in contact with the metal vapor plasma.

The invention is illustrated in the appended figure, which shows part of a hybrid welding set according to the invention, which usually comprises a gas laser (CO₂ laser) oscillator that produces a high-energy coherent monochromatic beam 3, an optical path equipped with deflection mirrors for bringing the laser beam 3 into a welding head located opposite the tube or pipe to be welded.

The welding head conventionally comprises a lens or one or more focusing mirrors so as to focus the laser beam 3 at one or more focal spots in the thickness of the workpiece 10, 11 to be welded and in the joint plane 9 obtained by the joining, in a butt, lap or other configuration, of the edges of the workpieces to be assembled.

Furthermore, an arc plasma jet is obtained by means of an electrode 1 and a plasma gas 4.

The laser beam 3 and the plasma jet combine in the welding head so as to be expelled together via the single orifice of the nozzle 2 in order to cause local power density concentration sufficient to melt the edges of the workpieces to be welded.

It has been demonstrated by the inventors of the present invention that, in order to obtain effective striking and subsequent quality welding, it is necessary:
during the striking phase, to use as first gas pure argon or a gas mixture containing essentially argon, typically 70 to 100% argon by volume, and the rest possibly being helium, hydrogen or any other appropriate non-oxidizing gas or gas mixture. This gaseous striking composition, coming from the source 4, is introduced into the welding head in the immediate vicinity of and/or around the electrode 1 so that the pilot arc is struck effectively between said non-consumable electrode 1 and the nozzle 2. Next, when this pilot arc has been struck it is transferred to the workpieces to be welded together by being expelled through the single orifice of the nozzle 2 of the welding head; and
at the moment of welding, to additionally supply the hybrid head with a second gas, coming from a gas source 5, so as to obtain a mixture of the first and second gases as a shielding gas used to shield the metal weld pool resulting from the combination of the plasma arc and the laser beam, that is to say the welded joint. The second gas is formed from pure helium or a helium-based gas mixture, which preferably contains 50 to 100% helium by volume, the remainder possibly being argon, hydrogen, nitrogen, carbon dioxide, oxygen or any other appropriate gas or gas mixture.

However, according to the invention, to obtain effective welding, that is to say without the formation of a harmful plasma coming from the shielding gas upon contact with the metal vapor plasma and therefore without a large proportion of the laser beam 3 being absorbed, it is essential to control, adjust, regulate or choose the volume flow rate of the first gas (Q1, where Q1 is not zero) and the volume flow rate of the second gas (Q2) in such a way that a flow rate of the second gas substantially higher than that of the first gas is obtained (Q2>Q1).

The gas streams are managed by means of a conventional control unit 6 in such a way that, until correct striking has occurred, it supplies the welding head with plasma gas (4), whereas once the pilot electric arc has been detected by the control unit 6 the latter opens a solenoid valve (not shown) so as to deliver the shielding gas (5) in order to increase, for example, the helium content in the head so as to change from a gaseous atmosphere containing predominantly argon, used to strike the pilot arc, to a gaseous atmosphere containing predominantly helium that can be used for welding.

The striking cycle is, for example, the following:
opening of the valve (not shown) controlling the influx of the plasma gas 4 around the electrode, for example an argon flow rate of about 5 l/min;
a current of low amperage is delivered between the electrode and the nozzle so as to generate a pilot arc and, when the pilot arc has been detected, the welding head is brought up to the workpieces to be welded so as to create the arc plasma, which is sent toward the edges to be welded;
supply of the welding head with a shielding gas, for example with helium, at a flow rate of 20 l/min so as to shield the weld pool formed; and
emission of the laser beam 3 and setting of the intensity of the plasma arc to its welding set-point value.

The invention is particularly applicable to the welding of tubes or pipes, by axial or helical welding, or of tailored blanks intended to constitute at least part of a vehicle body component.

The invention may be used for joining together, by hybrid welding, metal workpieces having the same or different thicknesses and/or the same or different metallurgical compositions or metallurgical grades and/or the same or different thicknesses.

In addition, depending on the welding methods and preparations used, the joint to be welded is often characterized by a difference in level between the upper planes of each of the workpieces to be welded, thus resulting in the creation of a “step”; however, the reverse situation may also be encountered, namely joints of the tailored-blank type in which the upper planes are aligned but the lower planes of which are not on the same level and in which the “step” is located on the reverse side of the joint to be welded.

Welds of this kind are frequently found in the automobile industry in which the workpieces, once they have been welded, are drawn in order to give them their final shapes, for example the various components involved in the manufacture of a car body, and especially the doors, the roof, the hood and the trunk, or structural components of the interior.

Of course, in all cases the workpiece or workpieces to be welded and the welding head are made to undergo a movement of relative displacement one with respect to the other, that is to say either the workpiece or workpieces are stationary and the welding head moves, or vice versa.

Moreover, it goes without saying that the welding phase may be carried out in one or more passes, depending in particular on the diameter and the thickness to be welded.

1-19. (canceled).

20. A laser/arc hybrid welding process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas having a gas composition conductive to the striking of a pilot arc;
d) supplying said electrode with an electrical current and bringing said electrode into contact with said striking gas, thereby striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising a third flowrate, said third flowrate comprising a first flowrate of said striking gas combined with a second flowrate of a second gas, wherein said first flowrate and said second flowrate are adjusted so that 0<first flowrate<second flowrate; and
h) shielding at least part of said welding zone with said gaseous shielding atmosphere during said laser/arc hybrid welding process.

21. The laser/arc hybrid welding process of claim 20, wherein said striking gas comprises more than about 50% argon by volume.

22. The laser/arc hybrid welding process of claim 21, wherein said striking gas comprises between about 70% to about 100% argon by volume.

23. The laser/arc hybrid welding process of claim 20, wherein said striking gas comprises at least one additional, non-oxidizing compound selected from the group consisting of helium, H2, and N2, wherein said additional, non-oxidizing compound comprises between about 0.05% and about 30% by volume of said striking gas.

24. The laser/arc hybrid welding process of claim 20, wherein said gaseous shielding atmosphere comprises at least about 40% helium by volume.

25. The laser/arc hybrid welding process of claim 26, wherein said gaseous shielding atmosphere comprises between about 50% to about 100% helium by volume.

26. The laser/arc hybrid welding process of claim 20, wherein said gaseous shielding atmosphere comprises at least one additional additive compound selected from the group consisting of argon, H2, O2, CO2, and N2, wherein said additional additive compound comprises between about 30% by volume of said gaseous shielding atmosphere.

27. The laser/arc hybrid welding process of claim 20, wherein 2<third flowrate/first flowrate<55.

28. The laser/arc hybrid welding process of claim 27, wherein 3<third flowrate/first flowrate<50.

29. The laser/arc hybrid welding process of claim 28, wherein 10<third flowrate/first flowrate<40.

30. The laser/arc hybrid welding process of claim 24, wherein said pilot arc is struck between said electrode and said nozzle so as to subsequently obtain a plasma arc, said plasma arc and said laser beam are combined, and delivered via the same orifice in said welding nozzle.

31. The laser/arc hybrid welding process of claim 20, wherein said gaseous shielding atmosphere comprises helium and argon, the proportion of said helium by volume being greater than the proportion of said argon by volume.

32. The laser/arc hybrid welding process of claim 20, wherein said one or more workpieces have a thickness of between about 0.1 and about 70 mm.

33. The laser/arc hybrid welding process of claim 20, wherein said one or more workpieces are tailored blanks forming components of an automobile body.

34. The laser/arc hybrid welding process of claim 20, wherein said one or more workpieces are comprised of a metal or metal alloy chosen from the group consisting of clad steels, unclad steels, joining steels, high-yield-strength steels, carbon steels, steels having on the surface a zinc alloy coating, stainless steels, aluminum, and aluminum alloys.

35. The laser/arc hybrid welding process of claim 20, wherein said gaseous shielding atmosphere comprises argon and more than about 60% helium.

36. The laser/arc hybrid welding process of claim 35, wherein said gaseous shielding atmosphere further comprises at least one additional additive compound selected from the group consisting of argon, H2, O2, CO2, and N2.

37. The laser/arc hybrid welding process of claim 20, wherein said adjustment of said gaseous shielding atmosphere as said pilot arc is transferred to said first edge and said second edge.

38. The laser/arc hybrid welding process of claim 20, wherein said adjustment of said gaseous shielding atmosphere after said pilot arc is transferred to said first edge and said second edge.

39. The laser/arc hybrid welding process of claim 20, wherein said one or more workpieces are welded as to obtain a tube.

40. The laser/arc hybrid welding process of claim 20, wherein step d) further comprises detecting said pilot arc.

41. The laser/arc hybrid welding process of claim 40, wherein said action of bringing said hybrid welding head up to said one or more workpieces is carried out after said detection of said pilot arc.

42. The laser/arc hybrid welding process of claim 41, wherein said action of bringing said hybrid welding head up to said one or more workpieces is carried out after said detection of said pilot arc, and simultaneous with the introduction of said gaseous shielding atmosphere, said gaseous shielding atmosphere comprising at least about 50% helium by volume.

43. The laser/arc hybrid welding process of claim 24, wherein said laser beam is emitted simultaneous with said formation of said plasma arc, thereby combining said laser beam with said plasma arc.

44. The laser/arc hybrid welding process of claim 24, wherein said laser beam is emitted subsequent to said formation of said plasma arc, thereby combining said laser beam with said plasma arc.

45. A process for manufacturing automobile body components, wherein said components are comprised of workpieces welded in accordance with a process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas having a gas composition conductive to the striking of a pilot arc;
d) supplying said electrode with an electrical current and bringing said electrode into contact with said striking gas, thereby- striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising a third flowrate, said third flowrate comprising a first flowrate of said striking gas combined with a second flowrate of a second gas, wherein said first flowrate and said second flowrate are adjusted so that 0<first flowrate<second flowrate; and
h) shielding at least part of said welding zone with said gaseous shielding atmosphere during said laser/arc hybrid welding process.

46. A process for manufacturing a longitudinally or spirally welded tube or pipe, wherein the edges of said tube or pipe are welded in accordance with a process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas having a gas composition conductive to the striking of a pilot arc;
d) supplying said electrode with an electrical current and bringing said electrode into contact with said striking gas, thereby striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising a third flowrate, said third flowrate comprising a first flowrate of said striking gas combined with a second flowrate of a second gas, wherein said first flowrate and said second flowrate are adjusted so that 0<first flowrate<second flowrate; and
h) shielding at least part of said welding zone with said gaseous shielding atmosphere during said laser/arc hybrid welding process.
